(19) United States
(12) Patent Application Publication
(10) Pub. No.: US 2008/0065755 A1
(43) Pub. Date: Mar. 13, 2008

(54) Apparatus and method for automated presence status inquiries

(75) Inventors: Rami Caspi, Sunnyvale, CA (US); William J. Beyda, Cupertino, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/506,743

(22) Filed: Aug. 18, 2006

(51) Int. Cl. G06F 15/173

(52) U.S. Cl. 709/224

(57) ABSTRACT

In some embodiments, presence inquiry system may include one or more of the following steps: (a) a memory comprising, (i) presence information submitted from at least two presence providers, (ii) a requestor's presence information, and (iii) an access determination program that checks a requestor's caller ID received from a phone call to determine whether the requestor is allowed access to an entity's presence information, (b) a processor coupled to the memory that executes the access determination program.

### FIELD OF THE INVENTION

This invention relates to presence and presence management systems that communicate presence information. In particular, this invention relates to a presence system that manages the availability of presence information across multiple service providers of trusted colleagues to the mobile user.

### BACKGROUND OF THE INVENTION

In computer and telecommunications networks, presence information conveys availability and willingness of a user (called a presentity) to communicate. A user's client provides presence information to a presence service to be stored and distributed to other users (called watchers) to convey its communication state. Presence information has wide application in voice over IP (VoIP) and instant messaging (IM).

A user client may publish a presence state to indicate its current communication status. This published state informs others that wish to contact the user of their availability and willingness to communicate. The most common use of presence today is the status indicator displayed on most instant messaging clients. A more simple everyday example is the ‘on-hook’ or ‘off-hook’ state of a telephone receiver, resulting in a distinctive ring tone for a caller. Some states that offer extended information on the user's availiability are “free for chat”, “away”, “do not disturb”, and “out to lunch”, which are often seen on many modern instant messaging clients. Rich information such as user mood and location may be also included. Presence is different from traditional ‘on-hook’ telephone status in that it deals with the user not the device (you want to talk to a person, not to a telephone).

Users have the potential to publish different presence states depending on who the communicator (or watcher) is. A worker may only want colleagues to see detailed presence information during office hours, for instance. Some users may want to only publish information to a select few. Basic versions of this idea are already common in instant messaging clients as a ‘Block’ facility, where users can appear as unavailable to selected watchers.

Modern day presence systems afford a wealth of information about one's colleagues. Presence and identity information is far more sophisticated than simple out of the office or do not disturb flags in conventional messaging or telephony systems. However, presently, access to the presence and identity information of a colleague is only accessible from a graphical user interface (GUI), and only for people served by the same service provider.

Therefore, it would be desirable to have a simple automated method for extending presence and identity context information in an easy and accessible way across all service providers without requiring cumbersome procedures and menus or multiple log-ins.

### SUMMARY OF THE INVENTION

These and other drawbacks in the prior art are overcome in large part by a system and method according to embodiments of the present invention.

In some embodiments, a method for determining the availability of presence information to a requestor of the presence information may include one or more of the following steps: (a) calling a PIS provider that has access to at least two presence provider's presence network, (b) inputting a name of an entity whose presence information is desired, (c) obtaining the entity's presence information from a PIS database, (d) providing the entity's presence information to the requester, (e) authenticating the requestor's identity by the PIS provider, (f) determining if the entity is located in the PIS database, and (g) verifying the requestor has access to the entity's presence information.

In some embodiments, a presence inquiry system may include one or more of the following features: (a) a memory comprising, (i) presence information submitted from at least two presence providers, (ii) a requestor's presence information, (iii) an access determination program that checks a requestor's caller ID received from a phone call to determine whether the requestor is allowed access to an entity's presence information, and (iv) a text to speech program that when executed by the processor provides the requester with the entity's presence information in audible form, and (b) a processor coupled to the memory that executes the access determination program.

In some embodiments, a machine readable medium comprising machine executable instructions may include one or more of the following features: (a) access instructions that determine if a caller has access to a presence inquiry database having at least two presence provider's presence information, (b) input instructions that receive entity information from the caller, (c) retrieve instructions that retrieve an entity's presence information from the presence inquiry database, (d) delivery instructions that deliver the entity's presence information to the caller if the caller has access, (e) search instructions to determine if the entity's presence information is located in the presence inquiry database, (f) verification instructions to determine if the caller has access to the entity's presence information.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 shows one implementation of a presence network in an embodiment of the present invention;

FIG. 2 show an implementation of a presence inquiry service network in an embodiment of the present invention;

FIG. 3 shows an implementation of a presence inquiry service responder in an embodiment of the present invention;

FIG. 4 shows a flow diagram of a presence inquiry service in an embodiment of the present invention.

### DETAILED DESCRIPTION OF THE INVENTION

The following discussion is presented to enable a person skilled in the art to make and use the present teachings. Various modifications to the illustrated embodiments will be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings.

In some embodiments of the present invention, a service provides presence and identity information across multiple service providers of trusted colleagues to a mobile telephone user. Since GUI's are not always available, having an easy way to quickly access presence information over a TUI (telephone user interface) would be helpful.

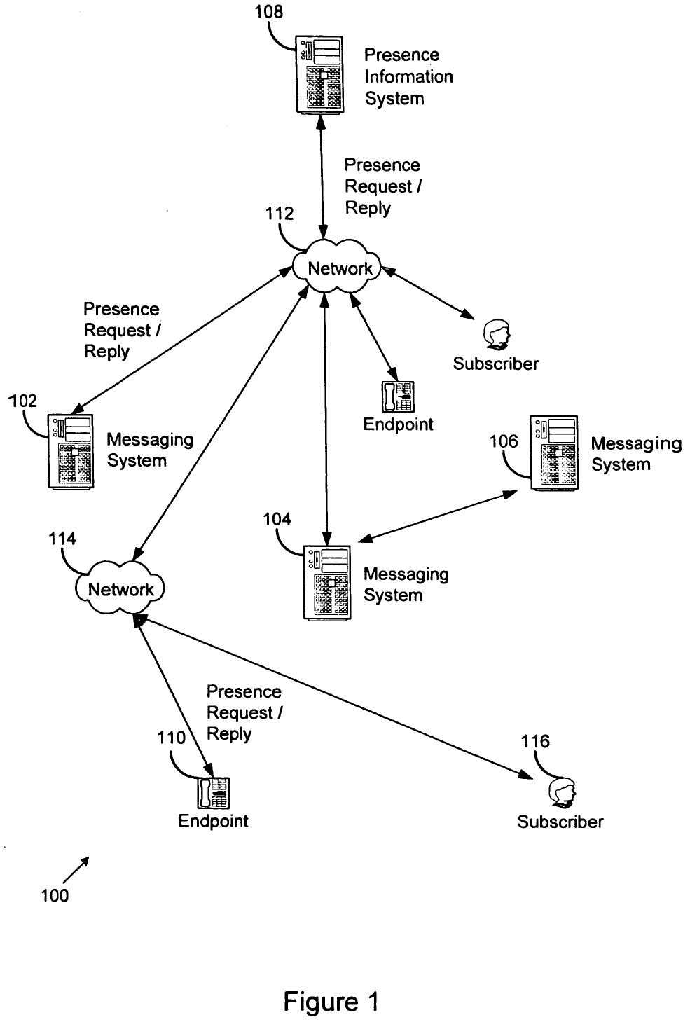

With reference to FIG. 1, a presence system network 100 is shown. The entities interacting in the network 100 may include messaging systems 102, 104, and 106, a presence information system 108, endpoints 110 (such as computer, phone, or cell phone), and/or other entities. The messaging systems 102-106 may subscribe to the presence information system 108 to obtain presence information on behalf of a subscriber. As will be described in more detail below, the presence information system 108 may allow or block access to the presence information in a contact group-driven manner. The messaging systems 102-106 may be multimedia messaging systems, or may selectively process specific types of messages such as voice messages, fax messages, instant messages, or other messages. The messaging system 102-106 may, for example, represent home or business computers that execute messaging programs such as instant messaging programs, email programs, video conferencing programs, or other messaging programs. Presence information for a subscriber 116 may be communicated between the endpoints 110, the presence information system 108 and/or the messaging systems 102-106.

The entities may communicate over one or more networks 112, 114 or interconnection of networks. The entities 102-110 and networks 112, 114 may exchange information using a packet based protocol. For example, the messaging systems 102-106, presence information system 108, and endpoints 110 may employ the Real Time Protocol (RTP) over the User Datagram Protocol (UDP). Other protocols, including the Transmission Control Protocol/Internet Protocol (TCP/IP) or other network protocols may be additionally or alternatively employed. In addition, the signaling between the entities 102-110 may proceed according to the H.323 packet-based multimedia communications system standard published by the International Telecommunications Union (ITU). The network or interconnection of networks 112, 114 may include the Public Switched Telephone Network (PSTN) and may deliver data to home or business computers, programs, PDAs, pagers, cell phones, wireline phones, internet phones, or any other communication device, electronic system, or system component or program.

The entities in the network 100 may employ protocols that adhere to any desired specification. For example, the entities may employ the Session Initiation Protocol (SIP) developed for Internet conferencing, telephony, presence, events notification and instant messaging, the Jabber protocol, or SIP for Instant Messaging and Presence Leveraging Extensions (SIMPLE). The form and content of the presence information may be established according to protocols consistent with the Internet Engineering Task Force (IETF) Request for Comments (RFC) 2778 or IETF RFC 2779. Alternatively, the entities may employ extensions to RFC 2778 or RFC 2779, or may employ proprietary protocols.

The subscribers 116 interact with the network 100. A subscriber may be any entity that may be associated with presence information, including a human being, an electronic device, a computer program, or other entity. The subscriber 116 may have one or more presence states that may be relative to one or more endpoints 110. Table 1 shows examples of presence states and descriptions of the presence states.

TABLE 1

| Presence State | Description |
|---|---|
| ‘Available’ | The subscriber is in the office and available to |
| | receive messages. |
| ‘On the Phone’ | The subscriber is in the office, but is on the phone. |
| ‘In Office’ | The subscriber is in the office. |
| ‘Be Right Back’ | The subscriber is in the office but is not available. |
| ‘In Meeting’ | The subscriber is in the office but is not available |
| | because they are in a meeting. |
| ‘On Business Trip’ | The subscriber is not in the office and is not |
| | available to receive messages. |
| ‘Out of Office’ | The subscriber is not in the office and is not |
| | available to receive messages. |
| ‘On Vacation’ | The subscriber is not available to receive |
| | messages. |
| ‘No Interruptions’ | The subscriber is in the office but is not available |
| | to receive messages. |
| ‘Working Remotely’ | The subscriber is working and available, but not |
| | in the office. |
| ‘Unknown’ | It is not known whether the subscriber is available. |

The presence states shown in Table 1 may be applicable to an individual subscriber 116. The presence states may also be applicable to other entities, including aggregate entities such as workgroups, group mailboxes or group phone connections. For example, a presence state may reflect the availability of a group of customer service representatives in a complaint department. When no representative is available to handle the call, the associated presence state may be ‘On the Phone’. The presence information may reflect the availability of at least one member of the group, or may reflect other presence information applicable to the group as a whole.

For example, the ‘Be Right Back’ presence state indicates that the subscriber is in the office or otherwise available. However, the subscriber is temporarily away from the endpoint at which the subscriber receives messages. Different, fewer, or additional presence states may be used. As another example, the collection of presence states may simply be ‘Idle’, ‘Busy’, and ‘Away’.

Presence states may also reflect an aggregated media state. The aggregated media states may apply to specific types of communication or may apply over any other subset of endpoints associated with the subscriber. As examples, the aggregated media states may apply to voice communications, instant messaging, and email messaging. Accordingly, a subscriber that is associated with multiple endpoints (e.g., phone numbers, email addresses, or instant messaging addresses) may have a presence state that aggregates availability over any subset of the endpoints. For example, a subscriber with a desk phone and a cell phone may have an aggregated media presence state of ‘Busy’ when at least one of the phones is in use. As another example, the subscriber may have an aggregated media presence state of ‘Available’ when both phones are not in use. Table 2 shows examples of aggregated media states. Different, fewer, or additional aggregated presence states may be used.

TABLE 2

| Presence State | Note |
|---|---|
| ‘Busy’ | The subscriber is in the office but is currently busy. |
| ‘Online’ | The subscriber is in the office and is connected |
| | to an instant messaging service. |
| ‘Offline’ | The subscriber is disconnected from their instant |
| | messaging service. |
| ‘Unknown’ | The actual state of the subscriber is currently unknown. |
| ‘Available’ | The subscriber is in the office, and is not on the phone, |
| | interacting with instant messaging, or interacting with |
| | an email system. |

The endpoints 110 and/or subscribers 116 may communicate presence information to the presence information system 108. For example, the endpoints 110 may monitor subscriber activity and communicate a presence message to the presence information system 108. The presence message may indicate, as examples, that the subscriber has initiated a phone call, ended a phone call, started to type an instant message or email message, or may indicate any other presence information.

The presence state information may be communicated in the form of a presence document. The format of the presence document may adhere to any proposed or accepted standard for communicating presence information. In one implementation, the presence document is an extensible markup language (XML) document that identifies a subscriber and the presence or availability of the subscriber with respect to one or more ‘addresses’, including endpoints such as telephone numbers, email addresses, instant messaging addresses, or the like. When an endpoint publishes a presence document to the presence information system 108, the presence document typically only contains information about that particular endpoint. The presence information system 108 may then aggregate information from all of the subscriber's endpoints. The aggregate presence document may be made available in whole or in part to other endpoints that request the presence information.

The presence information system 108 receives the presence document. The systems 102-108 may process the presence documents and may maintain presence information for one or more subscribers. Alternatively or additionally, the messaging systems 102-106 may receive presence documents from the presence information system 108.

For example, the messaging system 102 may at any time poll or subscribe to the presence information system 108 for the current presence state of a subscriber. In response, the presence information system 108 may communicate a presence document for the subscriber to the messaging system 102. In such a case, the messaging system 102 acts as another endpoint with regard to receipt of presence information. The presence information system 108 need not send the presence document or populate the presence document with the requested information in every instance however. Instead, the presence information system 108 may manage the availability of the subscriber presence state.

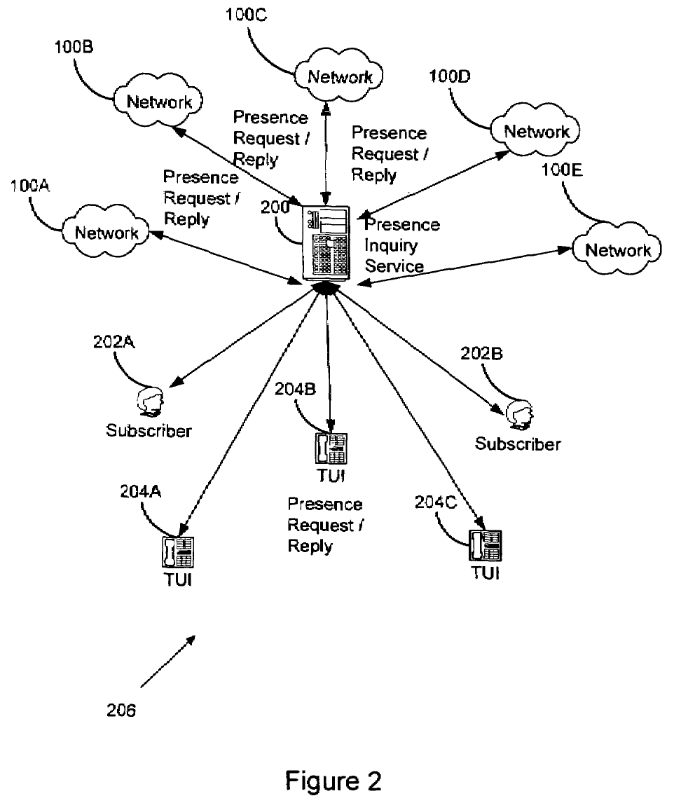

With reference to FIG. 2, an implementation of a presence inquiry service (PIS) network in an embodiment of the present invention is shown. Presence inquiry service 206 can work with any cell phone or regular wired phone using a TUI 204A-C. PIS 206 allows users 202A-B to use their cell or wired phones and receive the presence status of any of their buddies or other entities regardless of the presence service to which they subscribe. Presently none of the presence service providers share their user's presence information. Presence service providers 100A-E such as MSN™, AOL™, Yahoo messenger™, etc. will have their users provide information about themselves including defining a set of telephone numbers correlated to user 202, such as a cell phone number, home number, work number, etc when they register for the service.

PIS 206 has a service agreement with all presence service providers 100A-E to provide a list of all their users as well as their corresponding telephone numbers, which is then stored on a local data base 200.

PIS 206 application then correlates the access/block list of each user with the corresponding telephone numbers of each buddy or entity. For example, if John Doe has two buddies, Buddy-A and Buddy-B, PIS 206 application creates a database list which lists the telephone numbers of these buddies as part of the allow/block list of John Doe.

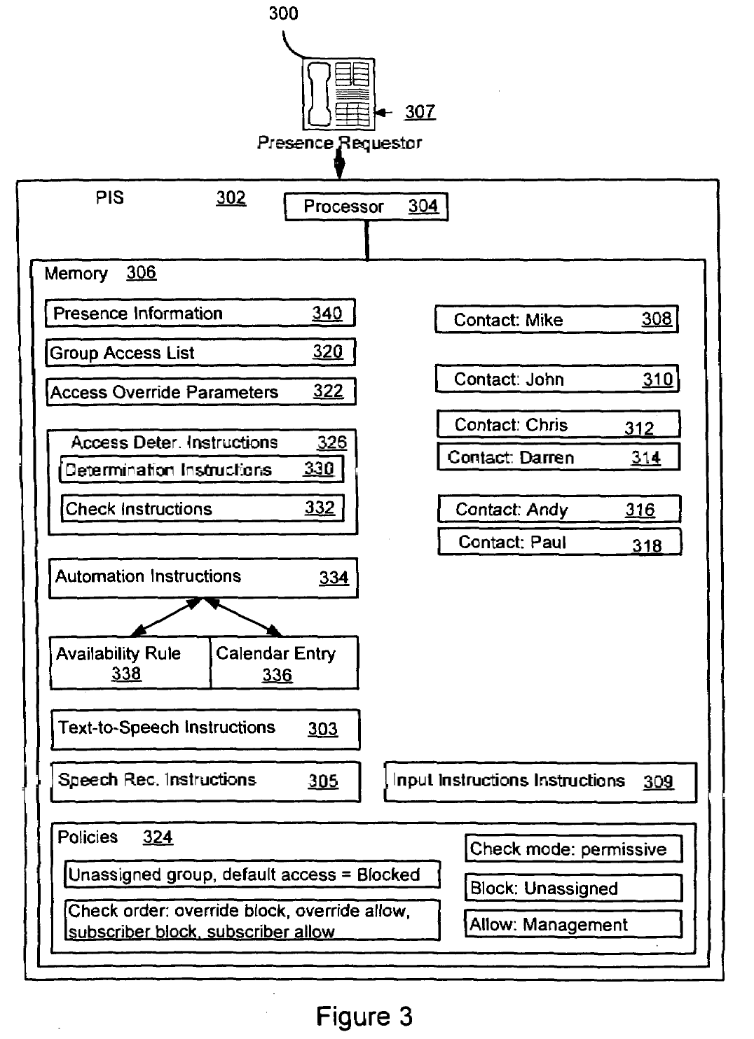

With reference to FIG. 3, an implementation of a presence inquiry service responder in an embodiment of the present invention is shown. A presence requester 300 requests presence information for a subscriber 204 from PIS 302. Presence requester 300 may be any of subscribers 202 interacting in the network 206. PIS 302 is described in more detail below.

PIS 302 includes a processor 304 and a memory 306. Memory 306 includes contacts 308, 310, 312, 314, 316, and 318 and can be organized into groups. A contact may be any entity that the underlying infrastructure allows the subscriber to define. A contact may be another subscriber, a subscriber of a different presence provider, a buddy, a group, a program, a document, automated programs (e.g., bots), or another entity. The contacts generally represent entities interested in the subscriber's presence.

In the example shown in FIG. 2, subscriber 202 has defined contacts 308, 310, 312, 314, 316, and 318 for Mike, John, Chris, Darren, Andy, and Paul. Access instructions 340 guide the presence requestor 300 with regard to contacts that are allowed access to subscriber presence information in database 340. PIS 302 maintains a contact access/block list 320. Contact access list 320 can be implemented to contain contacts that are allowed access to the subscriber presence information and a list of contacts that are blocked from access to the subscriber presence information.

PIS 302 may also include input instructions 309 that processes information received from requestor 300, such as caller ID number, phone information, and password. Instructions 309 processes any information received from requestor 300 and routes the information accordingly. For example, upon receiving the presence information of the desired entity, instructions 309 could route this information to access instructions 340.

PIS 302 may also include access override parameters 322. The override parameters 322 may allow access or block access to presence information regardless of the contact access parameter settings established by the subscriber. System policies 324 may establish the override parameters 322.

Memory 306 also includes an access determination program 326 and an automation program 328. Access determination program 326 may include determination instructions 330 and check instructions 332. Determination instructions 330 may search the contacts to ascertain to which contacts a presence requester belongs. The check instructions 332 examines the access parameters to ascertain whether the presence requester is allowed access to subscriber presence information. In an embodiment of the present invention, Access determination program 326 authenticates a presence requestor's 300 caller ID to determine whether requestor 300 is allowed access to an entity's presence information.

Automation program 334 may automatically change contact access parameters. For example the automation program 334 may process calendar entries 336 or availability rules 338 stored in the memory 306. When an availability rule 338 is applicable, or in response to a calendar entry 336, the automation program 334 may allow or block access to subscriber presence information.

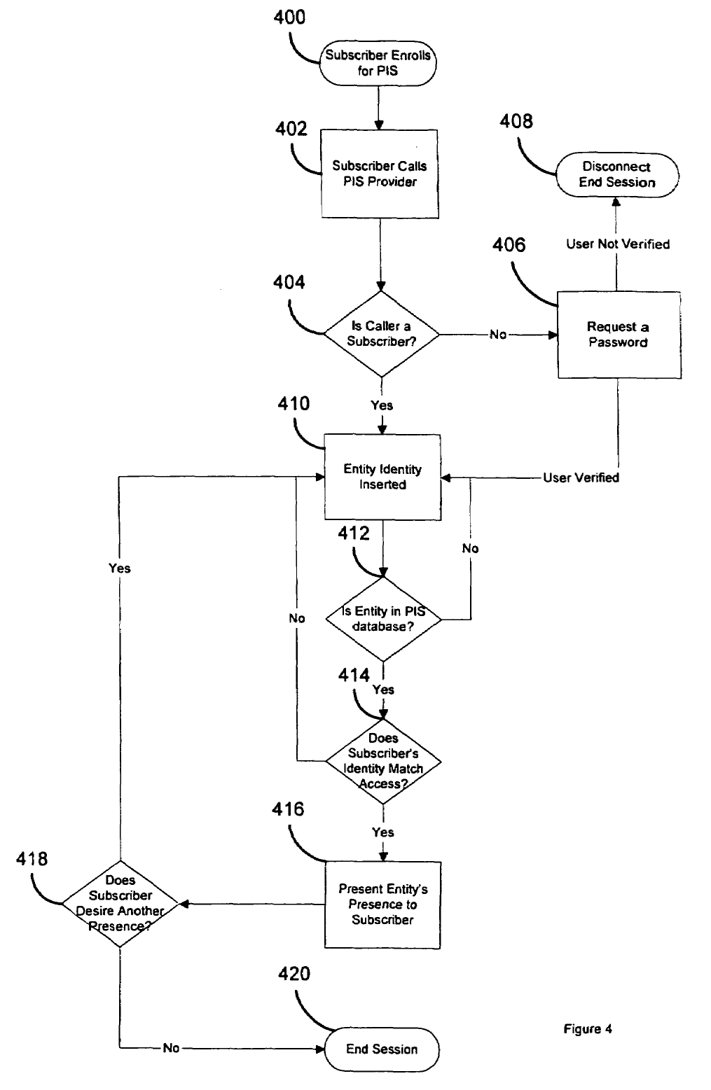

With reference to FIG. 4, a flow diagram of a presence inquiry service in an embodiment of the present invention is shown. The operation of PIS 206 is described with the following example and all PIS functions could be implanted on PIS 302. John Doe has registered to use PIS 206 at state 400 providing PIS 206 with his presence information and his cell phone, home phone, work phone, etc. John has also agreed to add the PIS service to his presence buddy list so that the service can continuously monitor his presence for other subscribers who may be interested in his presence information. John is out of town and away from his computer. However, John would like to know the presence information of Mary with whom he is having a meeting with that day. As John travels to the meeting in a taxi John calls PIS 206 to discover the presence status of Mary or one (or some) of the other participants in the meeting at state 402.

At state 402 John could call a number on his cell phone such as a toll free number (“1-800-XXX-XXXX’) of PIS 206 provider. John's caller ID information of the cell phone would be received by PIS 206. When John dials in to PIS 302, his caller ID is captured by PIS 302. When John asks for Mary's presence information his caller ID number is checked to see if it is on the buddy list of Mary. Only if Mary has John on the buddy list, and allows presence information to be displayed to John, is Mary's presence status sent. This is much simpler than John going through a cumbersome logon process to PIS 302. If John is calling from an unrecognized number based on his registration, PIS could then ask for John to input his user unique password received at his registration at state 406. If John's password is incorrect, then PIS 206 could end the session by disconnecting the call at state 408. However, if John's cell number or password are recognized by PIS 206, PIS 206 proceeds to state 410.

At state 410, John is prompted “Welcome to the presence inquiry service, whose presence would you like to know?” John can then enter Mary's name on the phone keypad 307 (FIG. 3) or by simply saying Mary's name into the cell phone mouthpiece since PIS can be implemented with speech recognition capability 305. PIS 206 then determines if Mary is a PIS subscriber and if her presence information is located within the PIS memory 306 at state 412. If Mary is not within PIS memory 306 or she is not a PIS subscriber, then PIS will redirect John back to state 410 to enter a different entity. If Mary is within PIS memory 306, then PIS examines whether John has access to Mary's presence information at state 414. This determination can be made from several factors, such as Mary having John's cell phone number, home phone number, name (transferred on caller ID), or a password if John is on another phone. It is contemplated that there are many number of ways for Mary to identify John in her presence information without departing from the spirit of the present invention. Further, it is noted it does not matter if Mary is part of a separate and incompatible presence service as PIS has a plurality of presence services database contents as described above.

If John is not located in Mary's presence information or if John is listed as a contact to be blocked from knowing Mary's presence information, then PIS returns John to state 410 to request a different entity. If John is located as a contact in Mary's presence information, then John is given Mary's presence information over the phone at state 416. PIS could use a text-to-speech (TTS) application 303 to read John Mary's presence information (e.g., in office, in a meeting, on business trip, others listed above). In addition to the presence identity information PIS 206 could also read any accompanying text that most presence service providers allow to add to one's presence state. This text string can include important additional information, and serve as a way to convey short messages between, contacts (e.g. Back on May 15^{th}, Contact John Public for assistance etc.).

When John is finished listening to Mary's presence information, PIS then asks John if he would like the presence information of another entity at state 418. If John does want to hear the presence information of another user, he is then routed to state 410 to begin the process. If John does not desire any further presence information, he is then routed to state 420 where the call is ended.

Embodiments of the present invention allow an easy and fast way of accessing presence information using simple phone devices, much like a “411 Service’ for presence services. It can correlate your caller ID phone number and buddy lists to allow you to receive information about your buddy's presence and identity context, without breaching the security provided by the allow/block list that each user sets. And, it can provide a central location for inquiring presence information across multiple service providers.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for determining the availability of presence information to a requestor of the presence information, the method comprising the steps of:
calling a PIS provider that has access to at least two presence provider's presence network;
inputting a name of an entity whose presence information is desired;
obtaining the entity's presence information from a PIS database; and
providing the entity's presence information to the requestor.

2. The method of claim 1, further comprising the step of authenticating the requestor's identity by the PIS provider.

3. The method of claim 2, wherein the identity is authenticated by verifying caller ID information transferred from the requestor.

4. The method of claim 1, wherein the PIS database contains the combined presence data of the at least two presence providers.

5. The method of claim 1, further comprising the step of determining if the entity is located in the PIS database.

6. The method of claim 1, further comprising the step of verifying the requestor has access to the entity's presence information.

7. The method of claim 6, wherein the verification of the requestor's access is performed by determining if a requestor's caller ID information is located on an entity's presence acceptance list.

8. A presence inquiry system comprising:
a memory comprising:
presence information submitted from at least two presence providers;
a requestor's presence information; and
an access determination program that checks a requestor's caller ID received from a phone call to determine whether the requestor is allowed access to an entity's presence information; and
a processor coupled to the memory that executes the access determination program.

9. The system of claim 8, wherein the requestor's caller ID information is received when a requestor calls the presence inquiry system.

10. The system of claim 8, wherein the memory further comprises a text to speech program that when executed by the processor provides the requestor with the entity's presence information in audible form.

11. The system of claim 10, wherein the presence information can include a text string providing additional information about an entity.

12. The system of claim 9, wherein the requestor inputs an entity's information for which presence information is desired from a phone.

13. The system of claim 12, wherein the requestor can type in the entity's information on a keypad or speak the entity's information over the phone.

14. A machine readable medium comprising machine executable instructions, including:
access instructions that determine if a caller has access to a presence inquiry database having at least two presence provider's presence information;
input instructions that receive entity information from the caller;
retrieve instructions that retrieve an entity's presence information from the presence inquiry database; and
delivery instructions that deliver the entity's presence information to the caller if the caller has access.

15. The machine readable medium of claim 14, wherein the caller calls from a telephone user interface.

16. The machine readable medium of claim 15, wherein the caller is granted access to the presence inquiry database by verifying caller ID information transferred from the caller.

17. The machine readable medium of claim 14, further comprising search instructions to determine if the entity's presence information is located in the presence inquiry database.

18. The machine readable medium of claim 14, further comprising verification instructions to determine if the caller has access to the entity's presence information.

19. The machine readable medium of claim 18, wherein the verification instructions determine if a caller's caller ID information is located on an entity's presence acceptance list.

20. The machine readable medium of claim 15, wherein the caller can type in the entity's information on a keypad or speak the entity's information over the phone.
